(19) United States
(12) Patent Application Publication
(10) Pub. No.: US 2004/0184653 A1
(43) Pub. Date: Sep. 23, 2004

(54) Optical inspection system, illumination apparatus and method for use in imaging specular objects based on illumination gradients

(76) Inventors: Richard L. Baer, Los Altos, CA (US); Xuemei Zhang, Mountain View, CA (US); Dietrich W. Vook, Los Altos, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/392,758

(22) Filed: Mar. 20, 2003

(51) Int. Cl. G06K 9/00

(52) U.S. Cl. 382/145

(57) ABSTRACT

An optical inspection system uses an illumination gradient to gradually spatially vary the intensity and/or specular characteristics of the illumination reflected from the surface of a specular object to determine surface gradients of the object. The surface gradients can be used to reconstruct a three-dimensional image of the object. The illumination gradient can be produced by an illumination apparatus that includes circular arrays of light-emitting elements. The illumination gradient can also be produced using an optical element that gradually alters the illumination intensity of the reflected illumination in accordance with the incidence characteristics of the reflected illumination on the optical element. The illumination gradient enables the use of numerous illumination angles to reduce error in estimated surface gradients without increasing imaging or processing time.

### CROSS-REFERENCE TO RELATED APPLICATIONS

This U.S. Nonprovisional Application for Patent is related by subject matter to copending and commonly assigned Nonprovisional U.S. patent application Ser. No. ______ (Attorney Docket No. 10030330), Ser. No. ______ (Attorney Docket No. 10030418) and Ser. No. ______ (Attorney Docket No. 10030331). Nonprovisional U.S. patent application Ser. No. ______ (Attorney Docket No. 10030330), Ser. No. ______ (Attorney Docket No. 10030418) and Ser. No. ______ (Attorney Docket No. 10030331) are hereby incorporated by reference in their entirety.

### BACKGROUND OF THE INVENTION

1. Technical Field of the Invention

The present invention relates generally to the field of optical inspection systems. More particularly, the present invention relates to optical inspection systems for imaging specular objects using illumination gradients.

2. Description of Related Art

Optical inspection systems are used in the machine vision industry to inspect objects, such as solder joints and components, on printed circuit boards for quality control purposes. When the observed object has a shiny specular surface, some optical inspection systems use the specular reflections off the object surface to estimate the surface tilt (angle) of the object surface. A single two-dimensional image of the surface can encode the surface angle information if the positions of the light are coded, for example, by color. The manual inspection process of these images is labor-intensive and prone to errors.

However, conventional optical inspection systems do not have the capability to produce images in greater than two dimensions. For example, conventional optical inspection systems typically illuminate the object surface with different illumination angles, and for each illumination angle imaged, the presence or absence of a value at a pixel location indicates the range of surface angles for the corresponding spatial location on the object surface. In most optical inspection systems, the number of illumination angles is limited, which results in severely quantized surface slope information.

For example, if three illumination angles are used, there are only three angles available to represent all surface angles ranging from 0-90 degrees. Although the angular separation of the illumination sources can be varied to change the range of surface angles represented by each illumination source, the number of quantization levels is still only three. To accurately reconstruct a three-dimensional image, finer sampling is needed, which requires the addition of more illumination angles. Increasing the number of illumination angles increases the number of image captures, resulting in longer image capturing and processing time.

Therefore, what is needed is an optical inspection system capable of producing illumination at a sufficient number of illumination angles to reconstruct a three-dimensional object surface without increasing the image capturing and processing time.

### SUMMARY OF THE INVENTION

Embodiments of the present invention provide an optical inspection system that provides an illumination gradient to gradually spatially vary the intensity and/or spectral characteristics of the illumination reflected from the surface of an object and received at a sensing apparatus. The image data produced at the sensing apparatus represents the intensity and/or spectral characteristic of the reflected illumination from spatial locations on the surface of the object. The image data can be used to determine surface gradients at the spatial locations on the surface of the object for use in reconstructing a greater than two-dimensional image of the shape of the surface of the object.

In one embodiment, the illumination gradient is produced by an illumination apparatus that includes circular arrays of light-emitting elements disposed to a plane in which the illuminated object is located. The illumination gradient can be disposed azimuthally around each of the circular arrays or in elevation across the circular arrays to vary the intensity and/or spectral characteristic linearly with respect to incidence angle. In other embodiments, the illumination gradient is produced using an optical element that gradually alters the illumination intensity of the reflected illumination in accordance with the angle of incidence on the surface of the optical element.

Advantageously, by creating an illumination gradient, the number of illumination angles can be increased to increase the surface gradient measurement accuracy without increasing the number of images required to determine the surface gradients. The light specularly reflected off the surface of the object can be processed by illumination intensity and/or spectral characteristic to determine the illumination angle, and therefore, the surface gradient. As a result, images of objects in greater than two dimensions can be displayed and analyzed to improve the accuracy in the detection of defective objects. Furthermore, the invention provides embodiments with other features and advantages in addition to or in lieu of those discussed above. Many of these features and advantages are apparent from the description below with reference to the following drawings.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a block diagram illustrating an optical inspection system in accordance with embodiments of the present invention;

FIG. 2 is a cut away view of a lighting ring capable of producing lighting gradients in accordance with one embodiment of the invention;

FIG. 3 is a simplified pictorial representation of the relationship between the lighting angle and the reception at the camera of light reflected off a specular surface of an object;

FIGS. 4A and 4B are top views of the light ring showing different lighting gradients in one embodiment for capturing both the surface gradient and the orientation;

FIGS. 5A-5C are top views of the light ring showing different lighting gradients in another embodiment for capturing both the surface gradient and the orientation;

FIG. 6 is a timing diagram illustrating the drive interval of light-emitting diodes (LEDs) with respect to the camera exposure interval to control the intensity of light received at the camera from the various LEDs.

FIG. 7 is a top view of the light ring showing a colored lighting gradient for capturing both the surface gradient and the orientation;

FIG. 8 is a simplified pictorial representation of an optical inspection system capable of modifying the grayscales of the light received at the camera based on the angle of entrance into the camera, in accordance with other embodiments of the present invention;

FIG. 9 is a chart illustrating of the transmissive properties of a glass filter as a function of the incoming light angle;

FIGS. 10A and 10B are graphical representations of the geometrical determination of the surface gradient based on lighting angles;

FIG. 11 is a cut-away view of a light ring having separately illuminated sections of lighting arrays, in accordance with further embodiments of the present invention;

FIG. 12 is a top view of the light ring shown in FIG. 11;

FIG. 13 is a block diagram illustrating exemplary hardware and processing components of the optical inspection system of the present invention;

FIG. 14 is a flow chart illustrating an exemplary process for reconstructing the shape of the surface of an imaged object and displaying the reconstructed shape, in accordance with embodiments of the present invention;

FIG. 15 illustrates a portion of a pixel array having a surface height associated with each pixel location;

FIG. 16A is a flowchart illustrating an exemplary process for performing a noise-tolerant reconstruction process, in accordance with embodiments of the present invention;

FIG. 16B is a flowchart illustrating an exemplary process for performing a bayesian noise-tolerant reconstruction process;

FIG. 17 illustrates a portion of a pixel array divided into cells of multiple pixels;

FIG. 18 is a flowchart illustrating an exemplary process for performing a multi-resolution reconstruction process, in accordance with embodiments of the present invention;

FIG. 19A is a flowchart illustrating an exemplary process for performing a multi-resolution bayesian reconstruction process;

FIG. 19B is a flowchart illustrating an exemplary process for performing a multi-resolution wavelet reconstruction process;

FIG. 20 is a pictorial representation of 2.5D images of an object,

FIG. 21 is a pictorial representation of an optical inspection system having a three-dimensional display, in accordance with embodiments of the present invention;

FIG. 22 is a block diagram illustrating the hardware and processing components of a three-dimensional display optical inspection system;

FIG. 23 is a flowchart illustrating an exemplary process for displaying three-dimensional images of an object, in accordance with embodiments of the present invention; and

FIG. 24 is a flowchart illustrating an exemplary process for manipulating the displayed three-dimensional image of an object, in accordance with embodiments of the present invention.

### DETAILED DESCRIPTION OF THE EXEMPLARY EMBODIMENTS

The numerous innovative teachings of the present application will be described with particular reference to the exemplary embodiments. However, it should be understood that these embodiments provide only a few examples of the many advantageous uses of the innovative teachings herein. In general, statements made in the specification do not necessarily delimit any of the various claimed inventions. Moreover, some statements may apply to some inventive features, but not to others.

Referring now to FIG. 1, there is illustrated a simplified schematic of an optical inspection (OI) system 10 capable of rendering a three-dimensional image 45 of the surface of an object 30, which can have both specular and diffuse surface reflection elements, in accordance with embodiments of the present invention. The OI system 10 includes an illumination source 50 for illuminating the surface of an object 30 and a sensing apparatus (e.g., camera) 20 for capturing an image of the surface of the object 30 within the field-of-view (FOV) of the camera 20. For example, in the simplified OI system 10 shown in FIG. 1, illumination 52 (e.g., light) emitted from the illumination source 50 is reflected off a portion of the surface of the object 30 and received by the camera 20. The reflected illumination (e.g., light) 55 can be specular, diffuse or a combination of specular and diffuse. As used herein, the term specular refers to a sharply defined light beam reflecting off a smooth surface, where the surface acts as a mirror, and the reflected beam emerges in only one direction determined by the angle of incidence of the incident light, and the term diffuse refers to reflection from a rough surface in which the reflected light emerges in all directions.

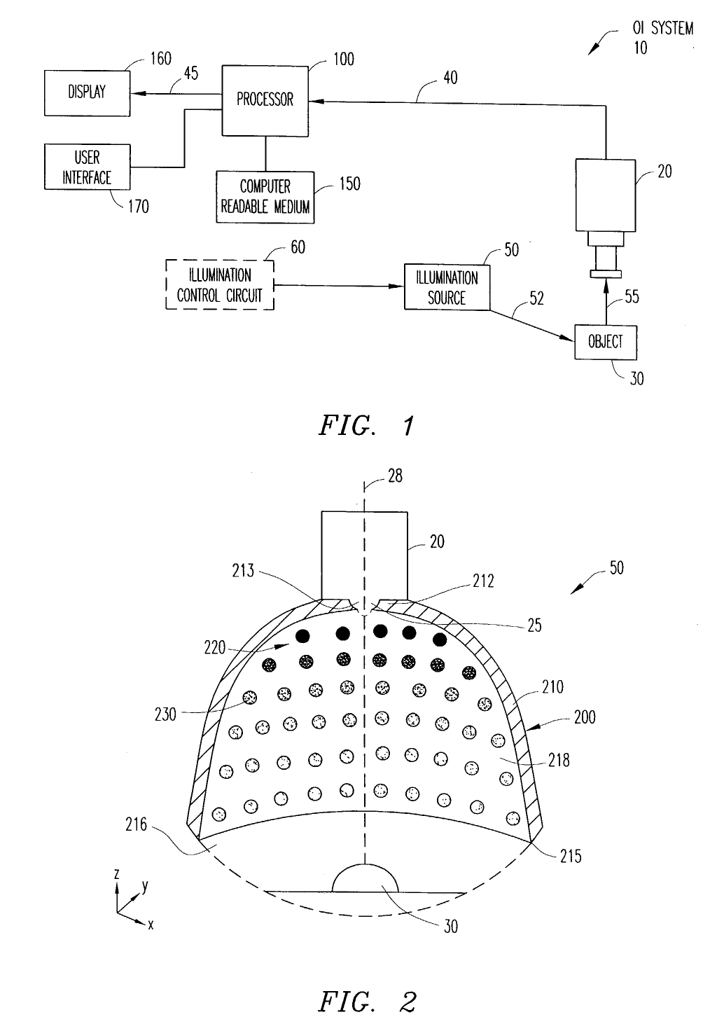

The illumination source 50 can be any suitable source of illumination 52. For example, the illumination source 50 can include one or more light-emitting elements, such as one or more point light sources, one or more collimated light sources, one or more illumination arrays, such as one or more circular arrays of light-emitting diodes, or any other illumination source suitable for use in OI systems 10. The illumination intensity can be constant, or in some embodiments, the intensity of the illumination 52 emitted by one or more of the light-emitting elements within the illumination source 50 can be controlled by an illumination control circuit 60. In addition, the wavelength of the illumination 52 emitted by the illumination source 50 can be controlled by the illumination control circuit 60 and/or chosen based on a number of factors, including manufacturer preferences. For example, some manufacturers may prefer green light or blue light to red light in certain applications. Examples of illumination sources 50 are shown in more detail in FIGS. 2-12.

One application of OI systems 10 is the inspection of solder joints on printed circuit boards. In many solder joint test systems, the illumination source 50 and camera 20 are attached together and jointly connected to an X,Y motorized gantry (not shown), which forms at least a part of a machine vision apparatus. The printed circuit boards are transferred into the OI system 10 by a conveyor belt (not shown), and the gantry is used to move the camera 20 to view selected objects 30 (e.g., solder joints) on the printed circuit boards. In other systems, the camera 20 and illumination source 50 are fixed and the printed circuit boards are moved into position. The OI system 10 analyzes the light that is specularly and/or diffusely reflected from the surfaces of the solder joints to determine whether all of the component leads have been soldered correctly.

To analyze the reflected light 55, image data 40 representing the two-dimensional images recorded by the camera 20 are passed to a processor 100 to perform a three-dimensional (or in other embodiments, a greater than two-dimensional) reconstruction of the shape of the surface of the object 30. The processor 100 can be a microprocessor, microcontroller, or other type of processing device capable of performing the functions described herein. In addition, the processor 100 can include multiple processors or be a single processor having one or more processing elements (referred to herein as separate processors).

Raw pixel values representing at least one illumination parameter, such as the illumination intensity and/or spectral characteristics, of the reflected light 55 captured in the two-dimensional images recorded by the camera 20 are used by the processor 100 to determine surface gradients of the object surface 30. Each surface gradient is a vector defining the slope of the object surface at a given spatial location, and includes information identifying both the surface tilt, which refers to the angle between the surface normal vector and the vector orthogonal to the plane in which the object is located, and the surface orientation, which refers to the direction that the surface is facing.

From the surface gradient information, the processor 100 can reconstruct a three-dimensional image 45 of the shape of the object surface by finding a set of surface heights that are consistent with the surface gradient information. The reconstructed three-dimensional image 45 can be stored in a computer-readable medium 150 for later processing or display. For example, the computer-readable medium 150 can be a memory device, such as a disk drive, random access memory (RAM), read-only memory (ROM), compact disk, floppy disk or tape drive, or any other type of storage device.

The three-dimensional image 45 of the object 30 can be displayed to a user of the OI system 10 on a display 160. The display 160 can be a three-dimensional display, such as a sharp screen, 3-D ball, user glasses (e.g., 3-D glasses or virtual reality glasses), or other type of three-dimensional display. In other embodiments, the display 160 can be a “rocking” two-dimensional display that uses a rocking motion of the image 45 to rotate the image 45 to create a three-dimensional image in the mind of the observer. The rocking can be automatic or controlled by a user. In further embodiments, the display 160 can be a two-dimensional display that displays a two-dimensional projection of the three-dimensional image 45 and that allows the user to rotate the angle of viewing to view the complete three-dimensional image. The viewing angle can be manipulated through a user interface 170, such as a joystick, virtual reality interface or other type of control. In addition, the user interface 170 can enable the user to control the information presented on the display 160. For example, through the user interface 170, the user can select only certain portions of the image 45 to be displayed in 3-D.

One example of an illumination source 50 is shown in FIG. 2. The illumination source 50 includes a light ring 200 containing circular arrays 220 of light-emitting elements 230 (e.g., light-emitting diodes) arranged concentrically about a central axis 28 of an aperture 25 of the camera 20. The axis 28 is orthogonal to the plane (x, y) in which the object 30 is located. The number of illumination arrays 220 is a function of the desired angular separation between the illumination arrays 220.

The light-emitting elements 230 are shown mounted on an inside surface 218 of a dome-shaped support structure 210. The support structure 210 further has a top surface 212 with an opening 213 of an area at least equivalent to the area of the aperture 25 of the camera 20 and a bottom surface 215 with an opening 216 sufficient in diameter to allow the light emitted from the light-emitting elements 230 to illuminate the surface of the object 30 placed under the support structure 210. The light ring 200 and camera 20 can be suitably mounted together on a machine vision apparatus that is capable of moving the light ring 200 and camera 20 into a position that the desired object 30 can be fully illuminated by the light ring 200 within the FOV of the camera 20.

The light ring 200 is designed to illuminate the object 30, such that at least one illumination parameter has an illumination gradient with respect to that illumination parameter. For example, the illumination parameter can be the illumination intensities of the light-emitting elements 230 and/or the spectral characteristics of the light-emitting elements 230. In the embodiment shown in FIG. 2, the illumination intensities of the individual light-emitting elements 230 in the light ring 200 are capable of varying gradually in order to produce an illumination intensity gradient sufficient to enable the surface gradient at a particular spatial (x,y,z) location on the surface of the object 30 to be estimated from the intensity of the specularly reflected light from that spatial location.

The location of the light-emitting elements 230 on the inside surface 218 of the dome-shaped structure 210 will be defined herein using the celestial navigation-based terms of elevation, which is measured between the vector orthogonal to the x-y plane in which the object is located and the vector pointing from the center of the field of view of the camera 20 to the light-emitting element 230 position, and azimuth, which is measured in the x-y plane between the y-axis and the vector pointing from the center of the field of view of the camera 20 to the light-emitting element 230 position. For example, as shown in FIG. 2, the illumination intensity can be varied to produce an illumination gradient in elevation of the light ring 200 in the z-direction along the direction of the axis 28. Thus, the light-emitting elements 230 within the center illumination array 220 nearest the top opening 213 have the lowest intensity and the light-emitting elements 230 within the peripheral illumination array 220 nearest the bottom opening 216 have the highest intensity. It should be understood that in other embodiments, the illumination intensity gradient can be reversed. It should also be understood that numerous other illumination gradients can be achieved, depending on the user or manufacturer preferences. In addition, other examples of illumination gradients based on intensity and/or spectral characteristics are described below and shown in FIGS. 4A, 4B, 5A-5C and 7.

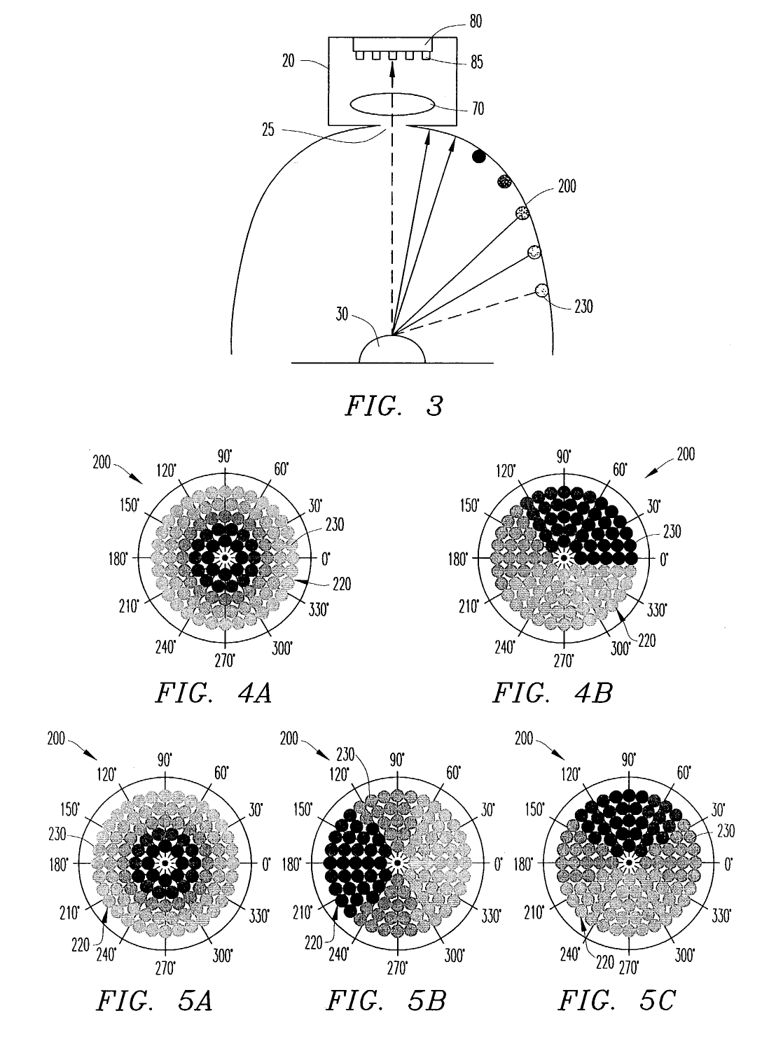

Referring now to FIG. 3, the camera 20 includes a sensor 80 that can produce image data (e.g., raw pixel values) that represent the intensity of the reflected light. When the camera 20 captures an image of the surface of the specular object 30, the image contains contributions from a range of light-emitting element 230 locations on the light ring 200. The extent of this range of locations depends on such factors as the focal length, magnification and f-number of the lens, and the distance between the object 30 and the light ring 200. Each of the light-emitting elements contributing to the captured image can be considered one of the source light-emitting elements 230. The light from the source light-emitting elements 230 contained inside of this range of locations is integrated together in the image, causing blurring. However, since the illumination intensities vary linearly with incidence angle, the average value of the intensity is unaffected by blurring except at the ends of the incidence angle range between illumination arrays 220. Therefore, the surface gradient measurements, which are determined from the average intensity of the image, are also unaffected by blurring. In fact, some blurring may even be advantageous by obviating the need for light diffusing filters in the light ring 200.

The intensity of the actual received reflected light depends on other factors, such as the surface reflectivity and the distance between the object 30 and the source light-emitting element 230. The amount of information that is available in a single image may be insufficient to account for these factors. Therefore, in some embodiments, a single image under a fixed illumination gradient may not be adequate to measure the surface gradients of the object 30. In this case, two or more images under different illumination gradients can be used in order to reduce the sensitivity of the measurements to the reflectivity of the surface of the object 30, or to the area of the object surface that has a particular surface gradient. For example, the undesired sensitivities can be normalized out by dividing corresponding pixel values from pairs of images collected under different illumination gradients. The surface gradients could be determined by relating the measured ratio values in the image to the intensity characteristics of the source light-emitting elements 230.

The uncertainty in the measured surface gradient is also dependent in part on the size of the aperture 25. If the lighting pattern is spatially varied continuously, the highest possible measurement precision occurs when the aperture 25 is infinitely small. However, with a pinhole aperture 25, a limited amount of light enters the camera 20, and therefore, a longer exposure is needed, resulting in additional camera noise. Therefore, the size of the aperture 25 chosen can be a trade-off between the level of noise in camera measurements and the level of built-in uncertainty in surface gradient measurement.

In general, as shown in FIGS. 10A and 10B and with reference to FIG. 3, the surface gradient of the object 30 at a particular spatial location on the surface of the object 30 is determined from the geometrical relationship between the angle of incidence of light illuminating the surface at that spatial location and the angle of reflection of the light that passes through the aperture 25 and into the sensor 80 of the camera 20 via a lens 70. The angle of reflection is known based on the relative position between the sensor 80 and the object 30. From the recorded light level at a pixel 85 or group of pixels 85 corresponding to that spatial location of the object, the identity of the source light-emitting element 230 can be determined. A simple geometrical calculation determines the surface gradient that would direct light from that source light-emitting element 230 to the pixel 85.

FIGS. 10A and 10B are graphical representations of the calculation of the surface gradient from the measured illumination intensity using a normalizing image. A normalizing image is an additional image of the object captured with all of the light-emitting elements set at the maximum (brightest) intensity. If Xᵢ represents the pixel value for a particular image location when the image is captured under lighting configuration i and X₀ represents the pixel value of the same image location when the image is captured under uniform lighting with an illumination intensity level k₀, then the illumination intensity level corresponding to Xᵢ is:

L₁=Xᵢ/X₀*k₀. (Equation 1)

For example, in the elevationally-varying illumination gradient configuration shown in FIG. 4A, as will be described in more detail below, the illumination configuration has an illumination intensity level of:

L₁=α/(π/2)k₀, (Equation 2A)

where α is the elevation, measured between the vector orthogonal to the object plane and the vector pointing from the center of the field of view to the light-emitting element position. In azimuthally-varying illumination gradient configurations of the type shown in FIG. 4B, which will be described in more detail below, the illumination configuration has an illumination intensity of:

L₂=θ/(2π)*k₀, (Equation 2B)

where θ is the azimuth measured in the x-y plane between the y-axis and the vector pointing from the center of the field of view of the camera 20 to the light-emitting element 230 position. Therefore, from the image values X₁, X₂, and X₀:

α=X₁/X₀*π/2,θ=X₂/X₀*2π. (Equation 3)

With other illumination configurations, the elevation and azimuth can be similarly solved from image pixel values. Once the elevation and azimuth of the source light-emitting element is determined from the recorded illumination intensity, the surface normal of the corresponding spatial location on the object can be solved. For example, as shown in FIG. 10B, if \vec{V}₁ represents a unit vector pointing from the spatial location (x,y,z) on the object to the source light-emitting element, and \vec{V}₂ represents a unit vector pointing from the spatial location (x,y,z) to the camera, then the surface normal vector at this pixel position \vec{V}ₙ is the vector sum of \vec{V}₁ and \vec{V}₂, as follows:

\vec{V}ₙ=\vec{V}₁+\vec{V}₂. (Equation 4)

The surface normal vector represents the surface gradient at the spatial location (x,y,z) of the object.

Referring again to FIG. 2, the elevational illumination gradient shown in FIG. 2 is sufficient to estimate the surface tilt at a particular spatial location on the surface of the object. However, to reconstruct a three-dimensional image, it is important to also know the surface orientation at that spatial location. For example, if the surface tilt at a particular spatial location of the object 30 is determined to be 20 degrees, but the sloping direction of the object 30 at that spatial location is unknown, then the surface gradient is unknown. To determine the orientation of the surface gradient, the azimuthal position of the source light-emitting element 230 within the illumination array 220 around the axis 28 should additionally be ascertained.

The surface orientation can be identified by using a different illumination gradient that varies the illumination intensity of the individual light-emitting elements 230 azimuthally within each illumination array 220. For example, as shown in FIGS. 4A and 4B, when using a monochrome camera, a full determination of the positions (i.e., elevation and azimuth) of light-emitting elements 230 can be obtained using two images taken under different illumination intensity gradients. FIGS. 4A and 4B are top-down views of the light ring 200 showing the illumination intensity gradients and the azimuthal position of each of the light-emitting elements 230 circumferentially around the axis. It should be understood that the azimuthal positions in FIG. 4B have been arbitrarily set for illustrative purposes only.

In a first image taken under the illumination configuration shown in FIG. 4A, the illumination intensity of the light-emitting elements 230 varies between illumination arrays 220 with respect to the elevation of the illumination arrays 220, as described above in connection with FIG. 2, to estimate the surface tilt of the object. In a second image taken under the illumination configuration shown in FIG. 4B, the illumination intensity of the light-emitting elements 230 varies azimuthally within each illumination array 220. For example, as shown in FIG. 4B, the illumination intensity of the light-emitting elements 230 varies azimuthally around the axis to produce a clockwise illumination gradient. Thus, the light-emitting element 230 within each illumination array 220 positioned at 0 degrees azimuth has the highest intensity and the intensity of the light-emitting elements 230 within each illumination array 220 gradually decreases azimuthally from 360 degrees to 0 degrees, with the light-emitting element 230 within each illumination array 220 positioned closest to 1 degrees azimuth having the lowest intensity. It should be understood that in other embodiments, the azimuthal illumination gradient can be counter-clockwise.

From the intensity of the light reflected from the surface of the object 30, the azimuthal position of the source light-emitting element 230 within the illumination array can be determined. Combined with the previously measured elevation of the illumination array 220 of the source light-emitting element 230, the particular source light-emitting element 230 within the illumination array 220 can be determined. Once the particular source light-emitting element 230 is identified, the surface gradient can be measured. However, with only two images, the direction of measurement encoding is not spatially smooth due to the abrupt change from dark to light at 0 degrees. The abrupt change in lighting intensity can cause uncertainty in the direction of measurement at 0 degrees when the aperture is large, or when the image is not adequately focused.

Therefore, referring now to FIGS. 5A-5C, in other embodiments, the surface gradient can be estimated using image data captured in three images. In a first image taken under the illumination configuration shown in FIG. 5A, the illumination intensity of the light-emitting elements 230 varies between illumination arrays 220 with respect to the elevation of the illumination arrays 220, as described above in connection with FIG. 2, to estimate the surface tilt of the object. In second and third images taken under the illumination configurations shown in FIGS. 5B and 5C, respectively, the illumination intensity of the light-emitting elements 230 varies azimuthally within each illumination array 220. However, unlike FIG. 4B, the direction of measurement coding in FIGS. 5B and 5C is spatially smooth, and thus more tolerant of image blurring.

As can be seen in FIG. 5B, the light-emitting element 230 within each illumination array 220 positioned at 0 degrees azimuth has the highest intensity and the intensity of the light-emitting elements 230 within each illumination array 220 gradually decreases azimuthally in both directions from 0 degrees, with the light-emitting element 230 within each illumination array 220 positioned closest to 180 degrees azimuth having the lowest intensity. From the intensity of the light reflected from the surface of the object 30, two potential azimuthal positions of the source light-emitting element 230 within the illumination array 220 are identified. To resolve the ambiguity in the azimuthal position from which the light is reflected, a third image is taken under the illumination gradient shown in FIG. 5C. In FIG. 5C, the illumination gradient is rotated 90 degrees from the illumination gradient in FIG. 5B so that the light-emitting element 230 within each illumination array 220 positioned at 270 degrees azimuth has the highest intensity and the intensity of the light-emitting elements 230 within each illumination array 220 gradually decreases azimuthally in both directions from 270 degrees, with the light-emitting element 230 within each illumination array 220 positioned at 90 degrees azimuth having the lowest intensity.

A surface gradient can be estimated for each pixel by combining the surface tilt measurement, the two surface orientation measurements, and the location of the measured pixel relative to the center of the camera field of view. The estimated surface gradients can be combined to reconstruct a three-dimensional shape of the specular object.

However, since some surfaces are partly specular, it may be difficult to separate the specular and diffuse parts of the image. Therefore, in additional embodiments, to separate the specular areas, an additional image of the object is captured with all of the light-emitting elements set at a uniform illumination. Under uniform illumination, the specular areas of the object will appear much brighter than the diffuse areas, enabling the specular areas to be separated from the diffuse areas for later image processing. This additional image can also be used as a normalizing factor, as described above in connection with FIGS. 10A and 10B, to establish the pixel value corresponding to a reflection from the brightest light source. This additional image increases the total number of images per object to three or four, depending on the illumination gradient configurations used. However, even with the additional image, the amount of information obtained in the images greatly outweighs the amount of information obtained in the same number of images taken with a traditional ring lighting scheme.

One example of the output of an illumination control circuit 60 (shown in FIG. 1) that is capable of varying the illumination intensity of an array of photodiodes to obtain an illumination intensity gradient is shown in FIG. 6. The illumination intensity between photodiodes (e.g., LEDs) is varied by pulsing the LEDs in the array. The intensity of the LEDs is proportional to the overlap of their electrical drive pulses with respect to the exposure time interval of the camera. As can be seen in FIG. 6, the apparent intensity between two LEDs depends on the overlap between the drive time intervals of the LEDs, and not just on the duration that the LED is active. It should be understood that the type of illumination control circuit used to vary the illumination intensity is not limited to the type of illumination control circuit in FIG. 6, and any method of creating lighting variations and/or illumination gradients may be used.

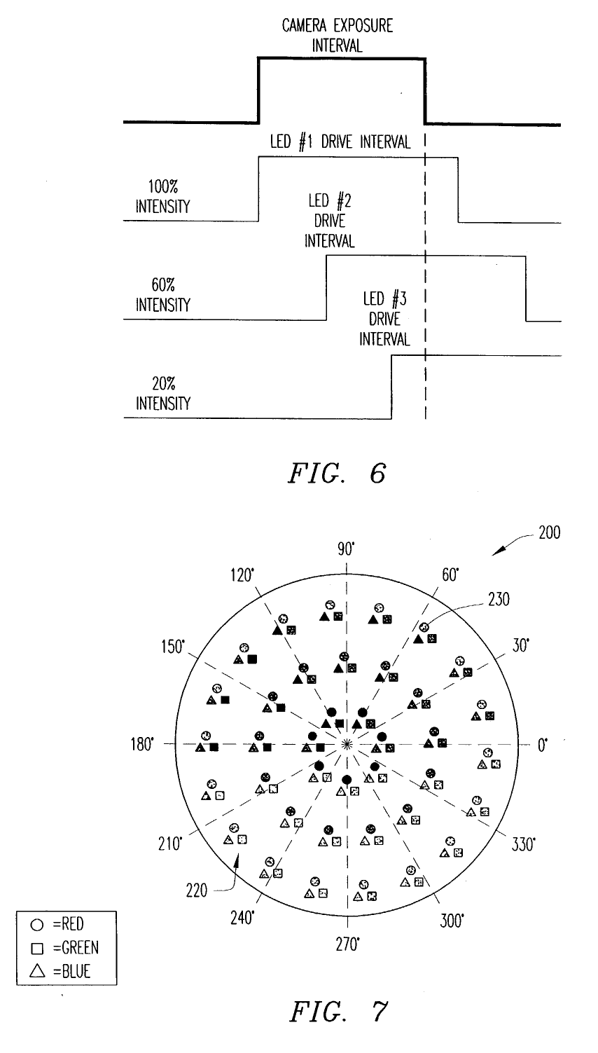

Referring now to FIG. 7, the number of images can be reduced by using a color camera and light-emitting elements 230 (e.g., LEDs) of several different colors in the light ring 200. The LEDs can be configured to create gradation in the illumination color (i.e., spectral characteristics) as a function of elevation and/or azimuth. For example, a triad of LEDs of different colors can be substituted for each of the single-color LEDs of FIG. 2. The color variation of the inside of the light ring 200 could resemble a rainbow or a color gamut plot. Therefore, in the embodiment shown in FIG. 7, the illumination gradient is an illumination wavelength gradient. A single image capture can be used to collect all of the information required for reconstruction of the shape of the object.

For example, as shown in FIG. 7, the intensities of the red LEDs vary in elevation between illumination arrays 220 in the light ring 200 to measure the surface tilt, while the green and blue LED intensities vary azimuthally within the illumination arrays 220 of the light ring 200 to identify the surface orientation. Specifically, the illumination intensity of the green LED within each illumination array 220 positioned at 0 degrees azimuth has the highest intensity and the intensity of the green LEDs within each illumination array 220 gradually increases azimuthally in both directions from 0 degrees, with the green LED within each illumination array 220 positioned closest to 180 degrees azimuth having the lowest intensity. The illumination gradient of the blue LEDs is rotated 90 degrees from the illumination gradient of the green LEDs so that the blue LED within each illumination array 220 positioned at 90 degrees azimuth has the highest intensity and the intensity of the blue LED within each illumination array 220 gradually increases azimuthally in both directions from 90 degrees, with the blue LED within each illumination array 220 positioned closest to 270 degrees azimuth having the lowest intensity. In this way, the data from all three images previously required using a single-color (white, red, blue, green, etc.) illumination source can be obtained in a single image. It should be understood that numerous variations on the color illumination gradients described above are possible to produce image data corresponding to the image data obtained from the illumination gradients shown in FIGS. 4A and 4B and/or FIGS. 5A-5C.

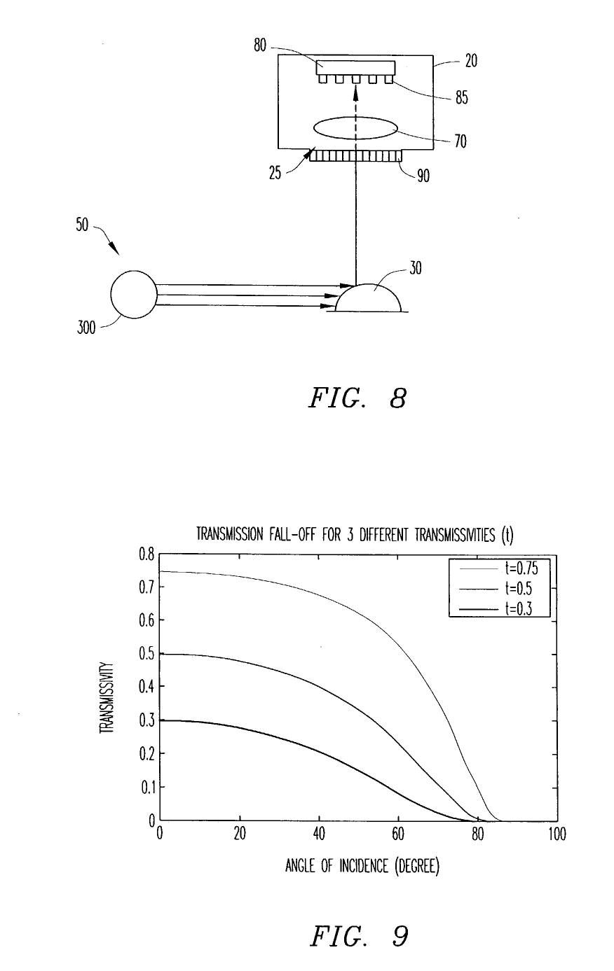

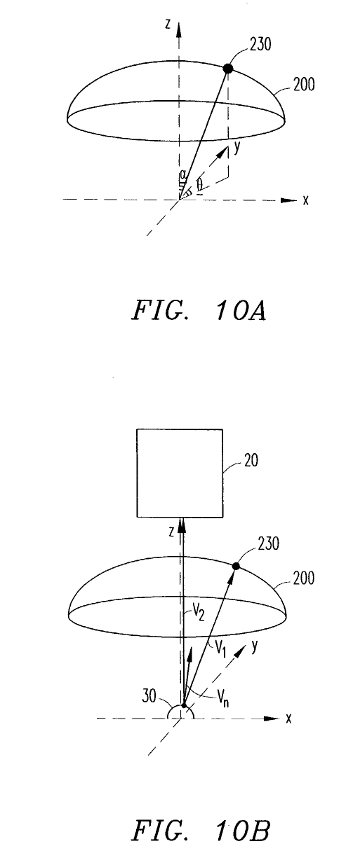

In other embodiments, instead of creating an illumination gradient by defining the intensities of the light-emitting elements themselves, as shown in FIG. 8, the illumination gradient can be created near the camera 20 using an optical element 90. Thus, as used herein, the term illumination gradient refers to either an illumination gradient created by the light-emitting elements having different intensities as described above or to an effective illumination gradient produced by filtering the reflected light. Even though light reflected from a large range of surface gradients can enter the camera 20, the reflected light enters the camera 20 at different locations in the camera aperture 25. Therefore, the optical element 90, for example, can be a patterned or directionally-selective aperture window 25 of the camera 20, such that light entering at different locations of the aperture 25, or entering the aperture 25 at different angles, will have different gray scales, or levels of illumination intensity at the sensor 80.

In other embodiments, as shown in FIG. 8, the optical element 90 can be a patterned (or directionally-selective) filter or plate 90 attached to the camera 20 near the aperture 25 to produce different gray levels for reflected light rays entering the aperture 25 from different angles. The plate 90 can be a piece of stained glass or plastic that is either uniform, or has a shading pattern across the field. If the plate 90 is a uniform piece of stained glass or plastic, light that enters at a non-zero angle of incidence with respect to the normal to the surface of the plate 90 has a longer path length through the plate 90, and therefore, is absorbed more than light that enters at zero angle of incidence. For large angles of incidence, a larger proportion of the reflected light is reflected back or absorbed compared to smaller angles of incidence.

When using an optical element 90 to create the illumination gradient, the angle of reflection can be determined from the recorded intensity. Therefore, the angle of incidence of the illumination source 50 should be held constant in order to determine the surface gradient. In addition, to capture sufficient information to estimate the surface gradients across the whole surface of the object, multiple images (e.g., four or more) under illumination from different angles of incidence may be required. For example, as shown in FIG. 8, the illumination source 50 can include four or more light sources 300, only one of which is shown for simplicity, producing light in four different directions. In one embodiment, the light sources 300 can include collimated light sources (e.g., parallel light coming in from four different directions, in four sequential captures). In other embodiments, the light sources 300 can include point sources in each of four directions (e.g., separate single LEDs illuminating from different directions, in four sequential captures). Since the angle of incidence is known at image capture and the incoming angle of the reflected light is encoded in the grayscale of the image, the surface gradient of the object 30 can be estimated.

However, when using a uniform glass plate 90, reflected light beams passing through the plate 90 from the left and from the right are encoded at the same grayscale level, so the sign of the surface gradient is unknown. Even though a surface gradient cannot be determined using a uniform glass plate 90, using a uniform glass plate 90 does provide a more accurate measurement of the surface tilt of a specular object 30 than conventional quantization of the object surface gradient, which provides only a few discrete values of surface tilt. When inspecting printed circuit boards, the additional surface tilt information can be used to assess the quality of the solder bonds more accurately.

The percentage of light transmitted through three uniform glass filters of three different transmissivities as a function of angle of incidence are shown in FIG. 9. The higher transmissivity filter allows more light in, but gives lower contrast between low and medium angles of incidence. The lower transmissivity filter passes only 30% of the light even for angles of incidence of zero, but gives better contrast between different angles of incidence.

Turning again to FIG. 8, if the optical element 90 is a patterned glass (or plastic) filter in front of the aperture 25, instead of recording the incoming light angles, the image data can be used to determine the approximate position at which the light enters the aperture 25. The patterned filter can be a separate patterned filter located in front of the aperture 25, or a patterned coating on the lens itself For example, a patterned filter with absorption varying gradually laterally from high to low across the surface of the laterally-patterned filter can be used. For illumination that comes in from only one direction, such as in the case of collimated illumination 300, the laterally-patterned filter 90 provides a one-to-one correspondence between the measured grayscale and the object surface gradient. However, a laterally-patterned filter requires rotation of the filter for each image capture to determine the surface gradient.

In another embodiment, the optical element 90 can be a transmissive LCD screen used in front of the aperture 25 to function as a patterned filter. By using a transmissive LCD screen, the direction of the transmission gradient can be altered between image captures without requiring the use of motors and hardware to rotate the filter. However, transmissive LCD screens are more expensive than patterned filters.

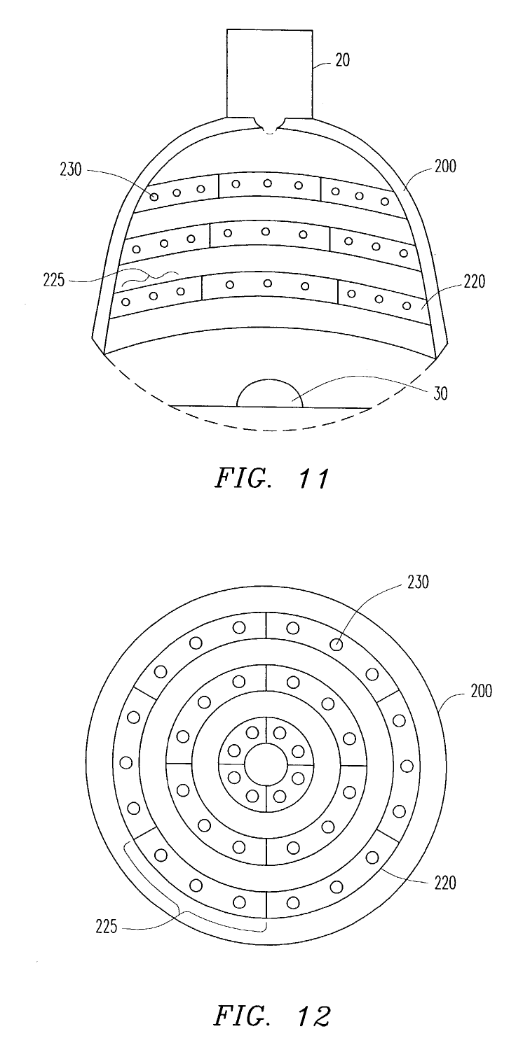

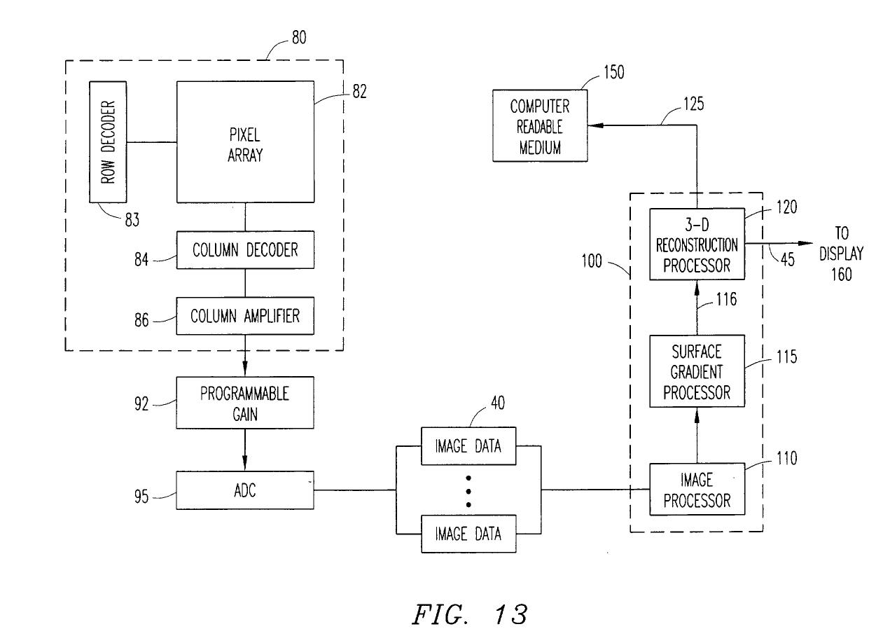

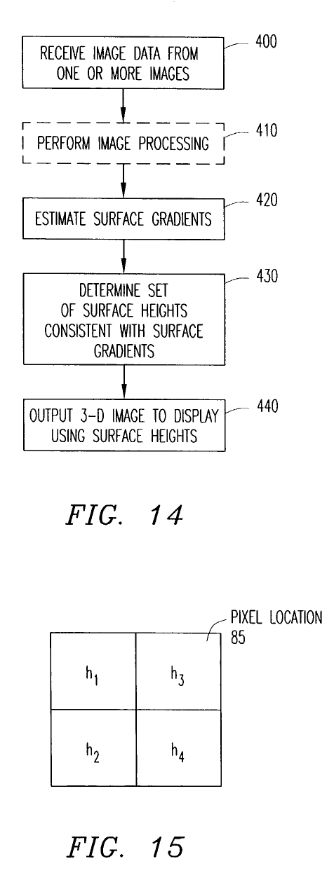

In further embodiments, as shown in FIGS. 11 and 12, the illumination source can be a programmable light ring capable of being operated by the illumination control circuit 60 (shown in FIG. 1) to create sectional illumination configurations by independently controlling the sections of the light-emitting elements (e.g., LEDs) 230 that are activated to generate illumination. For example, as shown in FIGS. 11 and 12, each array 220 of light-emitting elements 230 is divided into sections 225, each having a different azimuth on the light ring 200. Each of the sections 225 can be separately controlled by the illumination control circuit to independently illuminate an object 30 with different elevations and azimuths. Thus, for each image of the object 30 taken, the object 30 is illuminated by a different section 225 of an array 220.

To improve the speed and performance of the OI system, a pre-programmed number of images can be taken, and the particular section(s) 225 used to illuminate the object 30 for each image can be pre-programmed as a pre-established illumination pattern. Thus, for each object, the OI system runs a complete image cycle, taking images under illumination from each elevation and azimuth necessary to reconstruct a three-dimensional image of the object 30. To ensure that the image data from all of the images are properly combined to reconstruct the three-dimensional image, the object 30 remains in a fixed position relative to the camera 20.

When using a sectional illumination configuration, a “photometric” stereo method can be used to reconstruct the three-dimensional image. Photometric stereo methods are typically designed for diffusely reflecting surfaces, and surface gradients are derived from several images of the same object taken with illumination from different azimuths and possibly different elevations. For surfaces that have specular and diffuse reflections, surface reconstruction is possible by taking additional images with illumination from different azimuths and possibly elevations. Additional information on photometric stereo methods can be found in Solomon, et al., “Extracting the shape and roughness of specular lobe objects using four light photometric stereo,” IEEE Transactions on Pattern Analysis and Machine Intelligence, 18(4), pp. 449-454 (1996), and Coleman, et al., “Obtaining 3-dimensional shape of textured and specular surfaces using four-source photometry,” Computer Vision, Graphics, and Image Processing, 18(4), pp. 309-328 (1982), both of which are hereby incorporated by reference in their entirety.

Although photometric stereo methods of obtaining the surface gradients and reconstructing three-dimensional images of textured objects are well-known in the computer vision industry, photometric stereo methods have hitherto not been applied to optical inspection of mostly specular objects (e.g., solder joints) due to the additional processing required to analyze both the specular and diffuse reflections, and therefore additional time required for each inspection. Furthermore, specular reflection data have traditionally been sufficient to produce a two-dimensional image of the surface for inspection purposes, and therefore, there has not been a need to use three-dimensional reconstruction methods, such as photometric stereo.

However, due to recent advances in the dynamic range of charge coupled device (CCD) cameras, as well as the use of a programmable light ring 200 of the type shown in FIGS. 11 and 12, sufficient diffuse reflection information can be recorded from the areas of the image with partly specular surfaces using, for example, four or more images, each captured with illumination from a different elevation, azimuth or a combination of elevation and azimuth. From the geometry of the illumination configurations (illuminated sections) and the captured images, the surface gradients of the object can be estimated, and from the estimated surface gradients, the three-dimensional surface of the object can be reconstructed using a photometric stereo. It should be understood that other reconstruction methods are possible, such as shape from shading reconstruction methods. In addition, examples of other reconstruction methods are described below in connection with FIGS. 14-19. It should further be understood that the illumination configurations can be modified depending on the surface characteristics (specular and diffuse elements) of the object to optimize the image data for reconstruction purposes.

FIG. 13 is a block diagram illustrating a portion of the exemplary hardware and processing components of the optical system 10 of the present invention. The optical system 10 includes the sensor 80 having a pixel array 82 for capturing an image projected thereon and for generating an analog signal representative thereof A row decoder 83 and column decoder 84 select the rows and columns of the pixel array 82 for reading the analog signal representing the pixel values and resetting the photo detectors. A column amplifier 86 amplifies the analog signal and provides the analog signal to a programmable gain 92 before converting the analog signal to a corresponding digital signal by an analog-to-digital converter (ADC) 95.

The optical system 10 further includes the processor 100 for receiving the image data 40 including the digital signal(s) representing respective ones of one or more two-dimensional images taken under one or more illumination configurations. The processor 100 includes an image processor 110, a surface gradient processor 115 and a reconstruction processor 120. The image processor 110 is connected to receive the image data 40 representing the reflected illumination recorded at each pixel within the sensor 80 for each image and to perform any necessary pre-processing of the image data 40 prior to estimating the surface gradient and reconstructing the three-dimensional image.

For example, if a color sensor is used, the image processor 110 may need to demosaic the image. Demosaicing is a process in which missing color values for each pixel location are interpolated from neighboring pixels. There are a number of demosaicing methods known in the art today. By way of example, but not limitation, various demosaicing methods have included pixel replication, bilinear interpolation and median interpolation.

The surface gradient processor 115 takes as input the processed image data and estimates the surface gradients (surface gradient information 116) using any one of the methods described above. For example, when using illumination gradients, as described above in connection with FIGS. 2-9, the surface gradients can be estimated by determining the surface normal vectors, as described above in connection with FIG. 10. In other embodiments using sectional illumination configurations, a photometric stereo method can be used to estimate the surface gradients. However, it should be understood that any method of estimating the surface gradients can be used.

The reconstruction processor 120 is configured to receive surface gradient information 116 including the estimated surface gradients and reconstruct a three-dimensional (3-D) image 45 of the surface of the imaged object. The reconstruction processor 120 performs the 3-D surface reconstruction by finding a set of surface heights that are consistent with the surface gradient information. The surface height information 125 can be stored in the computer-readable medium 150 and/or used to provide the 3-D image 45 to the display 160.

In operation, as shown in FIG. 14, to perform a three-dimensional (or greater than two-dimensional) reconstruction of the surface of a specular object, one or more images of the object under different illumination configurations is taken (block 400) and the image data from the one or more images are pre-processed, if needed (block 410). From the image data and from the data representing the illumination configuration(s), surface gradients are estimated based on the known incidence angle of the light source and the angle of reflection of the light from the object surface (block 420). To reconstruct the three-dimensional object surface image, surface gradients are converted to surface heights (block 430) that can be output to a display capable of presenting to a user a three-dimensional image (or greater than 2-D image) of the object surface (block 440).

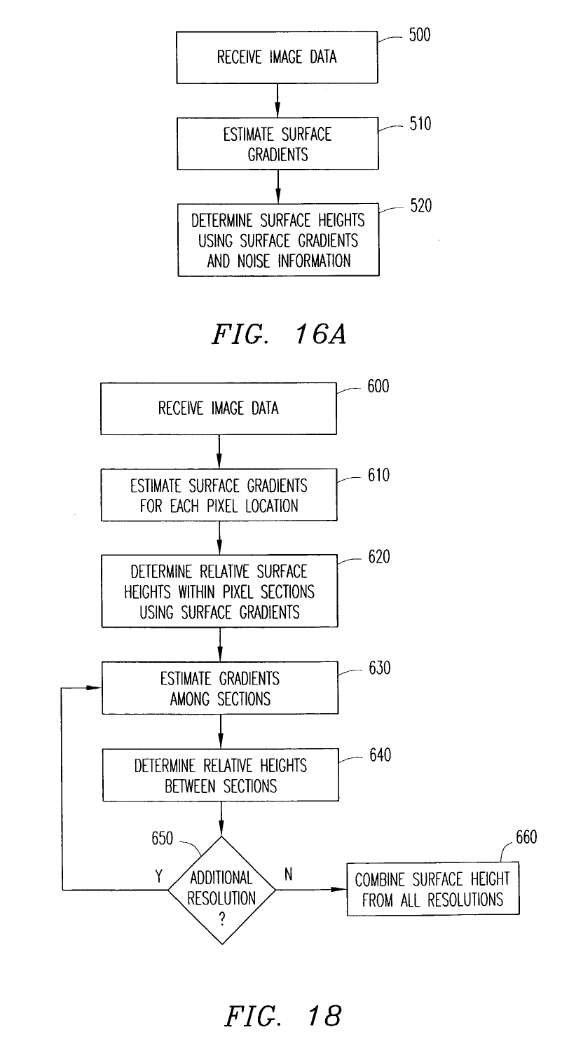

The surface gradient information obtained in OI systems tends to be noisy and heavily quantized due to the nature of the optical inspection system and the inability to precisely control the camera noise, the amount of stray light entering the camera and the positional relationship between the illumination source, the camera and the object. Therefore, in embodiments of the present invention, a noise-tolerant reconstruction method can be used to improve noise tolerance. For example, as shown in FIG. 16A, a noise-tolerant reconstruction method uses the received image data (block 500), estimates surface gradient information from the received image data and illumination configuration(s) (block 510), as described above, and determines surface heights by adding noise information representing the noise characteristics of the optical inspection system to the surface gradient information (block 520).

One example of a noise tolerant reconstruction method is shown in FIG. 16B, which uses a Bayesian reconstruction process 550 to improve noise tolerance. Since the optical inspection system uses digital image captures, the Bayes reconstruction process 550 is restricted to the discrete domain, assuming pixelated gradient maps and surface heights. If h_{i,j} represents the surface height for the pixel location (i,j), with i being the horizontal (x) pixel index, and j being the vertical (y) pixel index, the gradients Dx and Dy at (i,j) are defined as:

Dx_{i,j}=h_{i+1,j}−h_{i,j}, (Equation 5)

Dy_{i,j}=h_{i,j+1}−h_{i,j}. (Equation 6)

Since the Dx and Dy values are linear equations involving h values, the above equations can be written in matrix form as:

Dx=Tₓh, (Equation 7)

Dy=T_{y}h, (Equation 8)

where Tₓ and T_{y} are sparse matrices with entries of 0, 1, and −1, h is a vector of all surface height values, and Dₓ, D_{y} are vectors of all x and y gradients. For example, for the simplified case shown in FIG. 15 of a group of four pixel locations 85, each having an associated height (h₁, h₂, h₃ and h₄), with associated gradients dx₁, dx₂, dy₁ and dy₂, where dx₁ is (h₃−h₁), dx₂ is (h₄−h₂), dy₁ is (h₂−h₁) and dy₂ is (h₄−h₃), the above gradient equation can be written as:

$$\begin{matrix}{dx}_{1} \\ {dx}_{2} \\ {dy}_{1} \\ {dy}_{2}\end{matrix} = [ \begin{matrix}- 1 & 0 & 1 & 0 \\ 0 & - 1 & 0 & 1 \\ - 1 & 1 & 0 & 0 \\ 0 & 0 & - 1 & 1\end{matrix} ] [ \begin{matrix}{h}_{1} \\ {h}_{2} \\ {h}_{3} \\ {h}_{4}\end{matrix} ] \qquad ( Equation 9 )$$

For gradients (dx and dy) directly measured by (or estimated from) an optical inspection system described above in connection with FIGS. 1-12, a noise term can be added to the gradient data, as follows:

dx=Tₓh+nₓ, (Equation 10)

dy=Tₓh+n_{y}, (Equation 11)

where nₓ and n_{y} are vectors of additive noise values for all pixels of the gradient images. Equations 10 and 11 can be combined into:

d=Th+n, (Equation 12)

where:

$$d = ( \frac{dx}{dy} ) , T = ( \frac{{T}_{x}}{{T}_{y}} ) , n = ( \frac{{n}_{x}}{{n}_{y}} ) . \qquad ( Equation 13 )$$

The matrix T is fixed, and the vector d contains data (measured gradient values). To solve for the vector h, if the noise terms are assumed to be distributed as a zero-mean normal distribution N(0,Sₙ), then a Bayes estimation method can be applied. If the height values h have a normal prior distribution N(μ₀,S₀), then the gradient values d also have a normal distribution:

d˜N(Tμ₀,TS₀T′+Sₙ), (Equation 14)

because the height-to-gradient transformation T is linear.

The posterior distribution of surfaces heights P(h/d) is normal with a mean μ₁ of:

μ₁=J*d+(μ₀−J*T*μ₀), (Equation 15)

where J=S₀T′(TS₀T′+Sₙ)⁻¹. (Equation 16)

The gradient data d do not contain information about the absolute height of the object, but rather contain information about the relative heights among the pixels. Therefore, the solved height map ĥ has an arbitrary mean value. By assuming a prior distribution for h of zero mean (μ₀=0), the solution can be simplified to:

ĥ=μ₁=J*d. (Equation 17)

For fixed S₀ and Sₙ, the gradient-to-height matrix J does not depend on the data, and, as shown in FIG. 16B, can be pre-calculated and stored in memory (block 560). Once the gradient values are estimated (block 570), the height estimate then becomes a simple multiplication between a matrix and a vector (block 580). Therefore, for moderate-sized images with identical noise distribution for all gradient values, the Bayes process 550 can be implemented easily and can run quickly.

The Bayes process 550 also allows different error distributions for different pixels, making it possible to obtain an acceptable height reconstruction even when some of the pixels have missing gradient information, or unreliable gradients relative to other pixels. This can be useful for systems that cannot capture all possible gradient levels, such as an optical inspection system that can only capture a limited range of surface angles. The noise information can be incorporated into the estimation process in several ways. For example, the noise information can be included in the noise term Sₙ or in the prior mean and covariance matrix terms μ₀ and S₀.

For example, in an optical inspection system that can only capture specular reflections from surfaces having a maximum surface gradient of 23 degrees and diffuse reflections from surfaces having a maximum surface gradient of 45 degrees, for steep surfaces with surface gradients greater than 45 degrees, a confidence map can be used in conjunction with the Bayes process 550 to apply a best fit of the object surface to the image data. Prior to applying the Bayes reconstruction process 550, a confidence map can be created based on the estimated surface gradients. Within the confidence map, a weight or value is assigned to each pixel location indicating the confidence or reliability of the surface gradient at that pixel location. A smaller error distribution is applied to pixel locations having high confidence values, while a larger error distribution is applied to pixel locations having low confidence values. This confidence map can be used to set the prior covariance matrix in the Bayes height reconstruction formulation. In further embodiments, computer-aided design (CAD) data that provides information concerning the design specifications (e.g., shape or size) of the object can be used to supplement the image data by providing a more specific prior mean matrix μ₀.

In other embodiments, for large images (with a large number of pixel values), a multi-resolution reconstruction method that processes the image data in small components (e.g., pixel values from small sections of pixel locations) can be used to achieve global gradient consistency efficiently without requiring iterative searches, thereby improving the speed of calculations. As shown in FIG. 18, in a multi-resolution process, the received image data (block 600) are used to estimate the surface gradient for each pixel location (block 610), as described above. Thereafter, the relative surface heights within each of the sections of pixel locations are determined using the surface gradient information for the pixel locations in the section (block 620). For each level of resolution representing the size of the pixel sections, the surface gradients among the sections are estimated (block 630) and the relative surface heights among the sections are determined from the estimated surface gradients for the sections (block 640). Once the needed number of resolutions has been achieved depending on the image size (block 650), the surface heights determined with each resolution are combined to produce the final surface height information for the object (block 660).

For example, referring now to FIG. 19A, the multi-resolution reconstruction method can be used with the Bayesian process described above with reference to FIG. 16B. For large images, the matrix T is large, and the matrix inversion in Equation 16 becomes difficult. Even if the inversion is performed off-line, the resulting matrix T may still be too large to process. For example, for an image of size 100×100 pixels, the size of the matrix T will be 19800×19800, and thus matrix T will be very cumbersome to store and access.

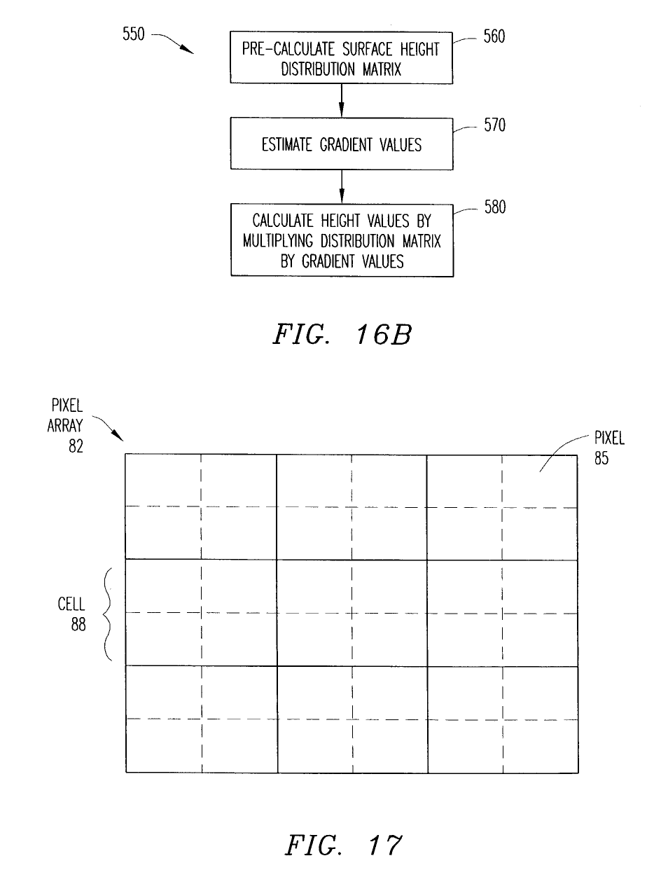

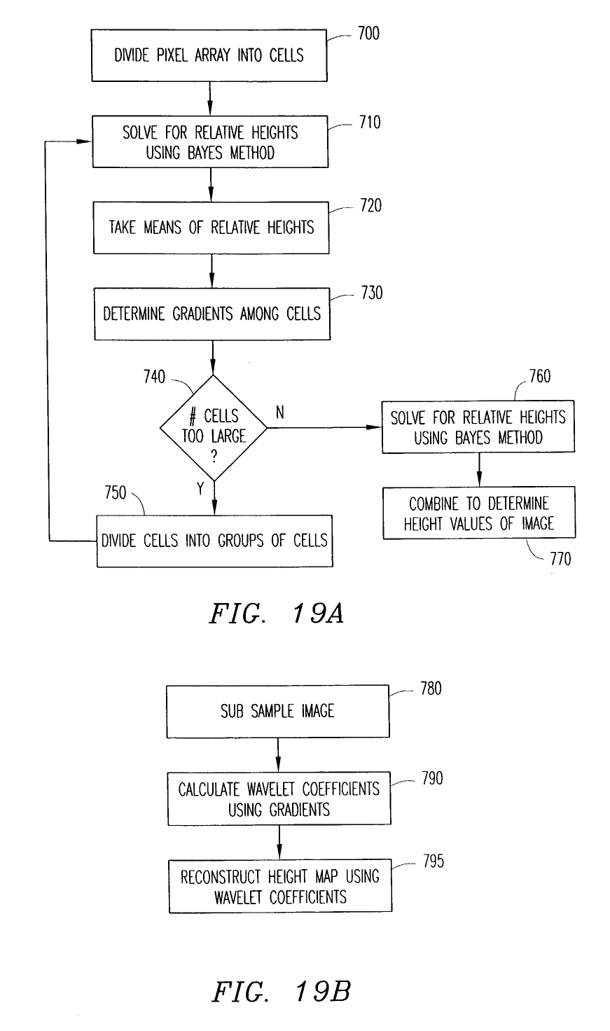

Therefore, to reduce the size of the matrix T, the pixels can be processed in only small areas at a time, while still achieving global gradient consistency by estimating the height values at multiple resolutions. As shown in FIG. 17, initially, the object images can be partitioned into individual cells 88 of m×m pixels 85 of the pixel array 82, where m is an integer greater than or equal to two.

Turning now to FIG. 19A, once the pixel array has been divided into larger “pixels” (cells) (block 700), if the estimated heights of pixel (i,j) in cell (p,q) are represented by ĥ_{i,j,p,q}, the relative heights within each cell can be solved according to the Bayes reconstruction method outlined in FIG. 16B (block 710), with mean height of each cell normalized to 0, so that:

$${\sum }_{i = 1}^{m} {\sum }_{j = 1}^{m} {\hat{h}}_{i , j , p , q} = 0. \qquad ( Equation 18 )$$

Each cell is then treated as one pixel having a height equal to the mean of the m×m individual heights (block 720). The gradients among the cells are easily computed from the original gradient images as (block 730):

$$\begin{matrix}{dx}_{p , q} = {\sum }_{j = 1}^{m} {\sum }_{i = 1}^{m} {h}_{i , j , p + 1 , q} - {\sum }_{j = 1}^{m} {\sum }_{i = 1}^{m} {h}_{i , j , p , q} \\ = {\sum }_{j = 1}^{m} {\sum }_{i = 1}^{m} ( {h}_{i , j , p + 1 , q} - {h}_{i , j , p , q} ) \\ = {\sum }_{j = 1}^{m} {\sum }_{i = 1}^{m} {\sum }_{k = 0}^{m} ( {h}_{i + k + 1 , j , p , q} - {h}_{i + k , j , p , q} ) \\ = {\sum }_{j = 1}^{m} {\sum }_{i = 1}^{m} {\sum }_{k = 0}^{m} {dx}_{i + k , j , p , g} , \\ {dy}_{p , q} = {\sum }_{j = 1}^{m} {\sum }_{i = 1}^{m} {h}_{i , j , p , q + 1} - {\sum }_{j = 1}^{m} {\sum }_{i = 1}^{m} {h}_{i , j , p , q} \\ = {\sum }_{j = 1}^{m} {\sum }_{i = 1}^{m} {\sum }_{k = 0}^{m} {dy}_{i , j + k , p , g}\end{matrix} \qquad ( Equations 19 )$$

After obtaining the gradients among the cells, the relative heights among the cells can be solved to obtain the estimated height values ĥ_{p,q} (block 760). However, if the number of cells is still too large for a direct solution using the Bayes reconstruction process outlined in FIG. 16B (block 740), the cells can be combined into groups of n×n larger cells (block 750), and blocks 710-730 can be recursively run until the height can be solved directly.

Once the estimated height values ĥ_{p,q} for the cells have been calculated (block 760), all of the multi-resolution solutions can be combined to obtain the final height map as follows (block 770):

h_{i,j,p,q}=ĥ_{i,j,p,q}+ĥ_{p,q}, (Equation 20)

where ĥ_{p,q} itself may be a combination of height estimates from several resolution levels.

In FIG. 19A, a block pyramid decomposition process was used for the multi-resolution processing. However, it should be understood that other ways of performing multi-resolution decomposition can be used as well. For example, as shown in FIG. 19B, a wavelet decomposition process can be used on the gradient images, and the different resolution levels can be solved for separately before being combined into the final solution. The preferred wavelet decomposition has a high frequency decomposition filter f_{high} that can be expressed as a convolution of a filter f₁ and the difference filter (−1 1):

f_{high}=(−1 1)\mathring{x}f₁. (Equation 21)

There are many commonly-used wavelet filters (e.g., the Daubechies filters) that can be expressed using Equation 18. For a height image h, the first level of wavelet decompositions can be calculated as described below, which results in 4 images: (1) the high frequency image h₂₂, (2) the low frequency image h₁₁, (3) the horizontally high frequency image h₂₁, and (4) the vertically high frequency image h₁₂. If S represents the operation of subsampling an image by a factor of two on each dimension (block 780), then by combining the wavelet decomposition operations with Equations 10, 11 and 21, the images are as follows:

$$\begin{matrix}{h}_{11} = S ( h {⊗}_{x} {f}_{low} {⊗}_{y} {f}_{low} ) , \\ {h}_{12} = S ( h {⊗}_{y} {f}_{low} {⊗}_{x} {f}_{low} ) \\ = S ( h {⊗}_{y} ( \begin{matrix}- 1 & 1\end{matrix} ) {⊗}_{y} {f}_{1} {⊗}_{x} {f}_{low} ) \\ = S ( Dy {⊗}_{y} {f}_{1} {⊗}_{x} {f}_{low} ) , \\ {h}_{21} = S ( h {⊗}_{x} {f}_{high} {⊗}_{y} {f}_{low} ) \\ = S ( h {⊗}_{x} ( \begin{matrix}- 1 & 1\end{matrix} ) {⊗}_{x} {f}_{1} {⊗}_{y} {f}_{low} ) \\ = S ( Dx {⊗}_{y} {f}_{1} {⊗}_{x} {f}_{low} ) , \\ {h}_{22} = S ( h {⊗}_{x} {f}_{high} {⊗}_{y} {f}_{high} ) \\ = S ( Dx {⊗}_{x} {f}_{1} {⊗}_{y} {f}_{high} ) \\ = S ( Dy {⊗}_{y} {f}_{1} {⊗}_{x} {f}_{high} ) .\end{matrix} \qquad ( Equations 22 )$$

The wavelet coefficients h₁₂, h₂₁, and h₂₂ can all be estimated (block 790) by substituting dx and dy for Dx and Dy in the above Equations 22. It should be noted that h₂₂ can be calculated from either dx or dy. For example, an average of dx and dy can be used to calculate h₂₂, but it should be understood that other combinations of dx and dy can be used as well. The wavelet terms then become:

ĥ₁₂=S(dy\mathring{x}_{y}f₁\mathring{x}ₓf_{low}), (Equation 23)

ĥ₂₁=S(dx\mathring{x}ₓf₁\mathring{x}_{y}f_{low}), (Equation 24)

ĥ₂₂=(S(dx\mathring{x}ₓf₁\mathring{x}_{y}f_{high})+S(dy\mathring{x}_{y}f₁\mathring{x}ₓf_{high}))/2 (Equation 25)

However, the wavelet term h₁₁ cannot be directly derived from dx and dy. However, h₁₁ can be treated as a height map by itself, and the gradients of h₁₁, denoted dx₁₁ and dy₁₁, can be estimated from the data dx and dy. From Equations 10 and 11 above:

$$\begin{matrix}{Dx}_{11} = {h}_{11} ⊗ ( \begin{matrix}- 1 & 1\end{matrix} ) \\ S ( h {⊗}_{x} {f}_{low} {⊗}_{y} {f}_{low} ) {⊗}_{x} ( \begin{matrix}- 1 & 1\end{matrix} ) \\ S ( h {⊗}_{x} {f}_{low} {⊗}_{y} {f}_{low} ) {⊗}_{x} ( \begin{matrix}- 1 & 0 & 1\end{matrix} ) ) \\ S ( h {⊗}_{x} ( \begin{matrix}- 1 & 1\end{matrix} ) {⊗}_{x} ( \begin{matrix}1 & 1\end{matrix} ) {⊗}_{x} {f}_{low} {⊗}_{y} {f}_{low} ) \\ S ( Dx {⊗}_{x} ( \begin{matrix}1 & 1\end{matrix} ) {⊗}_{x} {f}_{low} {⊗}_{y} {f}_{low} ) , \\ {Dy}_{11} = S ( Dy {⊗}_{y} ( \begin{matrix}1 & 1\end{matrix} ) {⊗}_{y} {f}_{low} {⊗}_{x} {f}_{low} ) .\end{matrix} \qquad ( Equation 26 )$$

Therefore, gradients for the wavelet term h₁₁ can be estimated as:

dx₁₁=S(dx\mathring{x}ₓ(1 1)\mathring{x}ₓf_{low}\mathring{x}_{y}f_{low}, (Equation 27)

dy₁₁=S(dy\mathring{x}_{y}(1 1)\mathring{x}_{y}f_{low}\mathring{x}ₓf_{low}), (Equation 28)

With known gradients dx₁₁ and dy₁₁, the elements in h₁₁ can now be solved recursively using either the block pyramid method or the wavelet pyramid method. Once all the wavelet coefficients h₁₁, h₁₂, h₂₁, and h₂₂ have been solved for, the wavelet coefficients can be reconstructed to the full height map using standard wavelet reconstruction procedures (block 795).

In the wavelet pyramid shown in FIG. 19B, the Bayes process was not used as described in FIG. 16B to perform the height estimates, and thus the noise tolerance is not as good as the block pyramid case. However, the wavelet pyramid calculation can be done faster than the Bayes calculation, and therefore the wavelet pyramid method can be useful for situations where the data noise is known to be low.

In all Bayes processes (e.g., FIGS. 16B and 19A), when transformations are applied on the gradient images, the noise terms among the transformed values will have different covariance than the original covariance for the gradients. Therefore the covariance matrix Sₙ for the noise term n should go through appropriate transformations as well if a Bayes height estimation is used. The Bayes height estimation method works optimally when the noise covariance is specified properly such that the level of uncertainty in the gradient data can be properly reflected in the posterior distribution (mean and covariance) of the height, resulting in more reliable height estimates.

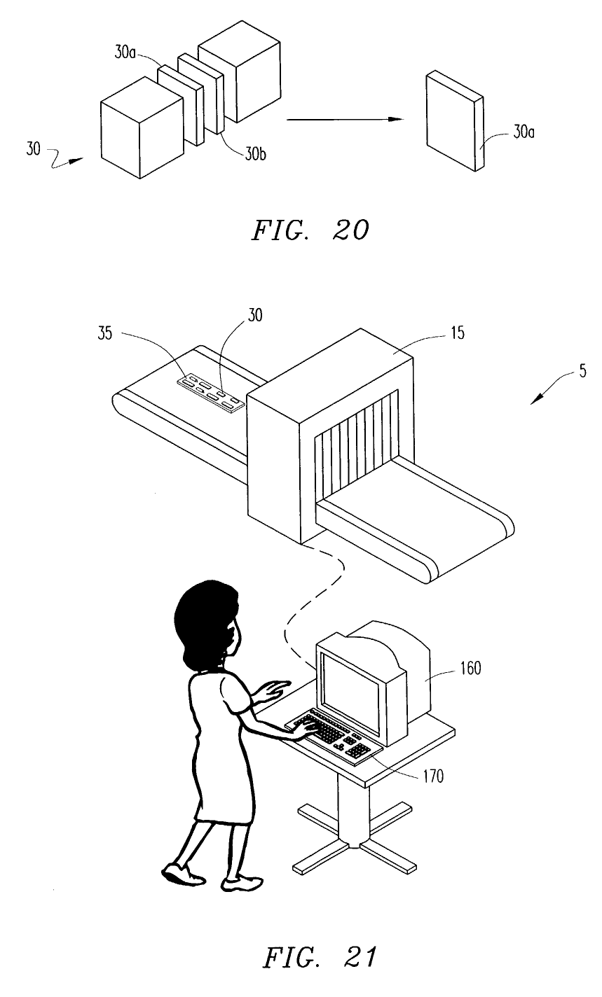

In other embodiments, instead of reconstructing a complete three-dimensional image, to reduce processing time, a “2.5-D” reconstruction of the image can be performed, in which a slice of the three-dimensional image is reconstructed using select data points. For example, as shown in FIG. 20, the surface of an object 30 can be divided into slices 30a and 30b, and the shape of the surface of a select one of the slices 30a can be reconstructed from the image data. To reconstruct a selected slice 30a of the image, the image data from the pixel locations within the selected slice 30a are used to estimate the surface gradients of the slice 30a and a reconstruction method (e.g., the Bayes reconstruction process described above in connection with FIGS. 16B and 19A) can be applied to the estimated surface gradients. From the reconstructed slice 30a of the image, various object features can be estimated, such as surface height. In the optical inspection system, the estimated object features can be compared to the design specifications for the object to determine whether there are any defects in the object. It should be understood that the term “slice” as it is used to define a “2.5-D” image refers to any portion of the 3-D image, and can be of any shape or size.

Referring now to FIG. 21, printed circuit board (PCB) inspection systems 5 typically include a machine vision apparatus 15 that images a printed circuit board (PCB) 35 to inspect objects 30 (e.g., solder joints and/or components) on the PCB 35 to determine whether one or more of the objects 30 is defective. The OI system 10 of FIG. 10 forms aspects of the PCB system 5. In many PCB inspection systems 5, only the images of the joint/components that were classified as defective by the apparatus 15 are presented to a user. Due to the large number of joints/components on each PCB 35, it is usually not feasible for the user to inspect all of the joints/components.

To enhance the ability of the user to identify defective joints/components, the image obtained by the apparatus 15 can be displayed in greater than two dimensions on a display 160. The display 160 can be a three-dimensional display, such as a sharp screen, 3-D ball, user glasses (e.g., 3-D glasses or virtual reality glasses), or other type of three-dimensional display. In other embodiments, the display 160 can be a “rocking” two-dimensional display that uses a rocking motion of the image 45 to rotate the image 45 to create a three-dimensional image in the mind of the observer. The rocking can be automatic or controlled by a user. In further embodiments, the display 160 can be a two-dimensional projection of the 3-D image that allows the user to rotate the angle of viewing. The viewing angle can be manipulated through a user interface 170, such as a keyboard (as shown), joystick, virtual reality interface or other type of control. In addition, the user interface 170 can enable the user to control the information presented on the display 160. For example, through the user interface 170, the user can select only certain portions of the image to be displayed in 3-D.

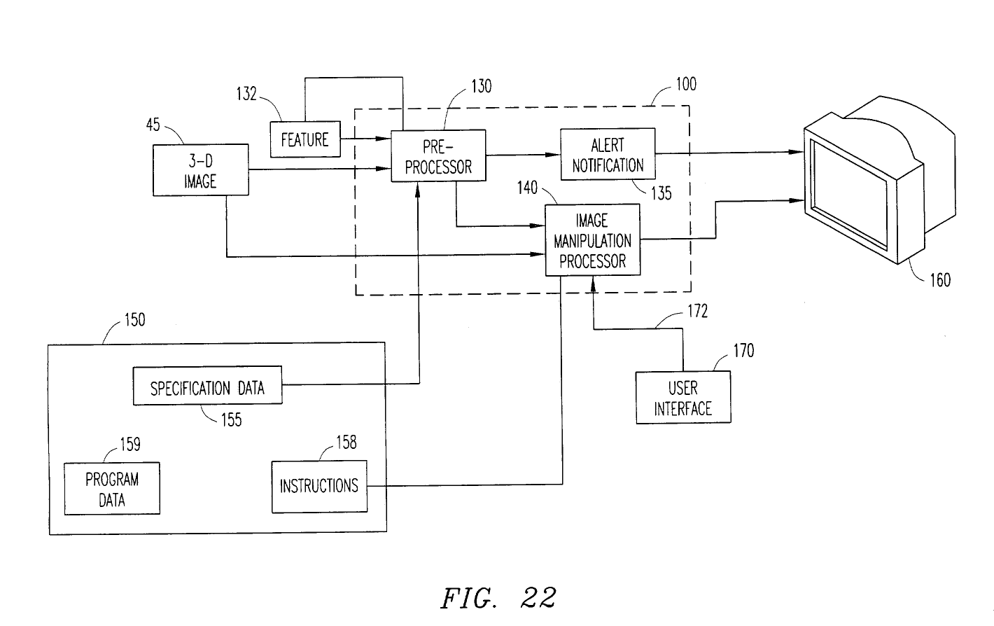

Turning now to FIG. 22, upon reconstruction of a greater than two-dimensional (e.g., 3-D) image of the object, the processor 100 can perform additional processing of the greater than two-dimensional (e.g., 3-D) image 45 prior to or during display of the 3-D image 45 on a display 160. For example, the processor 100 can include a pre-processor 130 that estimates various object features 132 and performs a comparison of the estimated object features 132 to pre-defined object specification data 155 stored in the computer-readable medium 150. The specification data 155 can include a threshold or range for the object features, outside of which the object may be considered defective. If the results of the comparison indicate that the object may be defective, the pre-processor 130 instructs an alert notification processor 135 to create and output an alert notification indicator to alert the user that an object may be defective and visual inspection by the user is required. The alert notification indicator can be a visual indicator on the display 160 and/or a sound indicator provided through a sound card or other sound device connected to the display 160.

In other embodiments, the pre-processor 130 uses features 132 identified from either the complete reconstructed 3-D image 45, a portion of the 3-D image (e.g., a 2.5-D image) or other image data that can be used to reconstruct the 3-D image to compare with the specification data 155 to automatically classify the object as defective or acceptable. For example, the pre-processor 130 can identify the surface height, volume, width or other feature 132 from the image data provided to the pre-processor 130, and compare the feature 132 with the specification data 155 for the object to automatically distinguish between good and bad parts. By automatically classifying objects, the amount of manual labor required to inspect PCBs can be reduced or eliminated. For example, if the comparison results are close, 3-D images 45 for those objects can be displayed. Otherwise, no image would need to be displayed. In other embodiments, the 3-D image 45 and/or results of the comparison can be used as program data 159 to train or program the pre-processor 130 to automatically classify objects based on new 3-D images or image data.

An image manipulation processor 140 can be connected to receive the 3-D image 45 from the pre-processor 130 to enhance the 3-D image 45 prior to display of the 3-D image 45 to the user. For example, the image manipulation processor 140 can isolate certain areas of the object surface that are of interest and highlight those areas or otherwise provide visual clues to the user of the problem areas on the object surface. The enhancements performed on the image can be pre-defined by the user or manufacturer and performed on all displayed 3-D images 45. For example, computer executable instructions 158 defining the enhancements can be stored in software modules in the computer-readable medium 150 and loaded and executed by the image manipulation processor.

In addition, during the display of the 3-D image 45 to the user, the image manipulation processor 140 can be connected to receive image manipulation instructions 172 from the user interface 170 based on an image manipulation input provided by the user to the user interface 170 to alter the 3-D image 45 displayed. For example, the image manipulation processor 140 can receive instructions 172 to display certain areas of the object surface or rotate the angle of viewing of the object surface.

In operation, as shown in FIG. 23, to provide the user with 3-D views of only those objects that may be defective, specification data on the objects can be pre-stored (block 800), so that upon reconstruction of the 3-D image of the object (block 810), the specification data can be compared to object features estimated from the 3-D image (block 820) to determine if the estimated object features are outside of tolerances for the object (block 830). If the comparison indicates that the object features are within tolerances (e.g., the object is not defective) (block 830), the 3-D image is not displayed to the user (block 840). However, if the comparison indicates that the object features are outside of tolerances (block 830), the user is alerted (block 850). If there are any image enhancements that need to be performed on the 3-D image (block 860), those image enhancements are performed (block 870) prior to display of the 3-D image to the user (block 880).

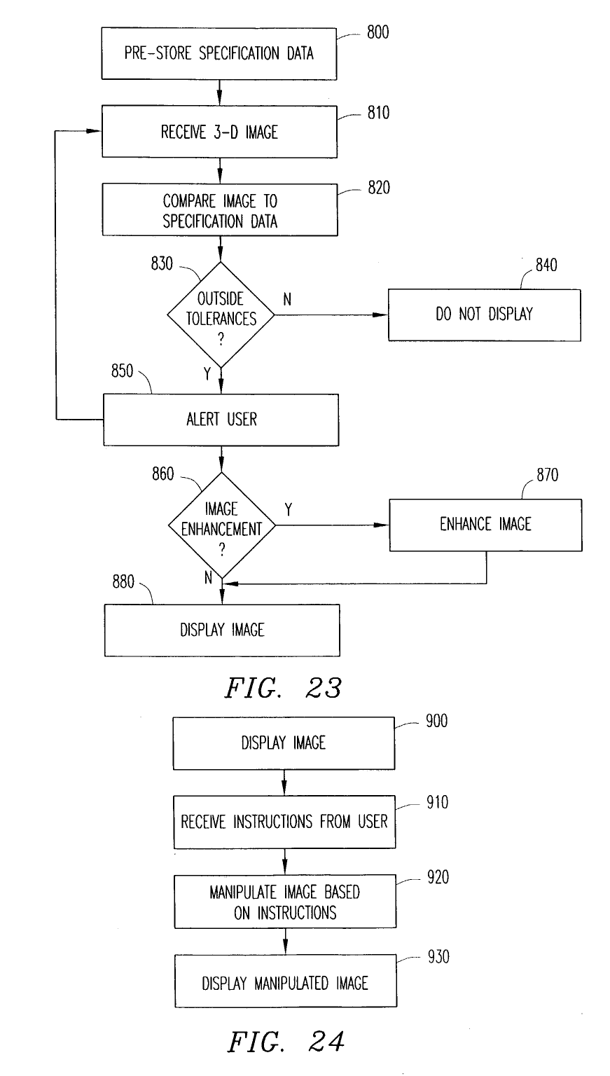

Referring now to FIG. 24, once the 3-D image is displayed to the user (block 900), the user can manipulate the 3-D image by providing image manipulation instructions to the OI system through a user interface (block 910). The Ol system is capable of manipulating the 3-D image in virtually any manner possible based on the user manipulation instructions (block 920). Once the 3-D image has been manipulated in accordance with the user's instructions, the manipulated 3-D image can be displayed to the user (block 930), and further manipulations can be performed until the user is able to determine whether the object is defective.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

We claim:

1. An optical inspection system, comprising:
means for receiving illumination reflected from the surface of an object; and
means for producing image data representing the intensity of the reflected illumination from spatial locations on the surface of the object; and
means for processing said image data to discern between illumination intensities of an illumination gradient associated with the reflected illumination to determine surface gradients at the spatial locations on the surface of the object.

2. The optical inspection system of claim 1, further comprising:
light-emitting elements disposed in concentric circular arrays around an axis orthogonal to a plane in which the object is located, said light-emitting elements producing the illumination gradient across at least a contiguous portion of said light-emitting elements.

3. The optical inspection system of claim 1, further comprising:
an optical element disposed between the object and said means for receiving to produce the illumination gradient by altering the illumination intensity of the reflected illumination over angles of incidence of the reflected illumination on said optical element.

4. The optical inspection system of claim 1, wherein said means for receiving comprises a sensing apparatus disposed relative to the object to receive the reflected illumination and said means for producing comprises an optical image sensor within said sensing apparatus.

5. An illumination apparatus for use in an optical inspection system, comprising:
light-emitting elements disposed in concentric circular arrays around an axis extending from a plane in which an object under inspection is located, said light-emitting elements being configured to illuminate the object with illumination characterized by at least one illumination parameter having an illumination gradient across at least a contiguous portion of said light-emitting elements.

6. The illumination apparatus of claim 5, further comprising:
a support structure including an inside surface on which said light-emitting elements are mounted to position said light-emitting elements at different azimuths and elevations with respect to the object.

7. The illumination apparatus of claim 5, wherein the light-emitting elements are configured to produce the illumination gradient in elevation.

8. The illumination apparatus of claim 5, wherein the light-emitting elements are configured to produce the illumination gradient in azimuth.

9. The illumination apparatus of claim 8, wherein the light-emitting elements are configured to produce the illumination gradient in at least two different azimuths.

10. The illumination apparatus of claim 5, wherein the at least one illumination parameter comprises illumination intensity.

11. The illumination apparatus of claim 10, wherein the at least one illumination parameter comprises at least one spectral characteristic of the illumination.

12. An optical inspection system for inspecting an object, comprising:
a sensing apparatus disposed in relation to the object to receive illumination reflected from the surface of the object, said sensing apparatus being configured to produce image data representing the intensity of the reflected illumination from spatial locations on the surface of the object, the image data for use in determining surface gradients at the spatial locations on the surface of the object; and
an optical element disposed between the object and said sensing apparatus to produce an illumination gradient by altering the illumination intensity of the reflected illumination over incidence characteristics of the reflected illumination on said optical element.

13. The optical inspection system of claim 12, wherein said optical element is selected from the group consisting of: a patterned aperture window of said sensing apparatus, a directionally-selective aperture window of said sensing apparatus, a patterned filter disposed in front of an aperture of said sensing apparatus, a directionally-selective filter disposed in front of the aperture of said sensing apparatus, a patterned lens of said sensing apparatus, a directionally-selective lens of said sensing apparatus and a transmissive liquid crystal display screen disposed in front of the aperture of said sensing apparatus.

14. The optical inspection system of claim 12, further comprising:
four or more collimated light sources disposed in relation to the object to selectively illuminate the object with different angles of incidence.

15. An optical inspection system for inspecting an object, comprising:
an illumination source disposed in relation to the object to illuminate the object with illumination characterized by at least one illumination parameter having an illumination gradient; and
a sensing apparatus disposed in relation to the object to receive illumination reflected from the surface of the object, said sensing apparatus being configured to produce image data representing the illumination parameter of the reflected illumination from spatial locations on the surface of the object, the image data for use in determining surface gradients at the spatial locations on the surface of the object to reconstruct a greater than two-dimensional image of the shape of the surface of the object.

16. The optical inspection system of claim 15, wherein said illumination source comprises a light ring including light-emitting elements disposed in concentric circular arrays around an axis of an aperture of said sensing apparatus, the axis extending from a plane in which the object is located, said light-emitting elements being configured to produce the illumination gradient across at least a contiguous portion of said light-emitting elements.

17. The optical inspection system of claim 16, further comprising:
an illumination control circuit connected to control the illumination intensities of each of the light-emitting elements to produce the illumination gradient.

18. The optical inspection system of claim 16, further comprising:
a support structure including an inside surface on which said light-emitting elements are mounted to position said light-emitting elements at different azimuths and elevations with respect to the object.

19. The optical inspection system of claim 16, wherein the light-emitting elements are operable to produce the illumination gradient in elevation in a first illumination configuration.

20. The optical inspection system of claim 19, wherein the light-emitting elements are further operable to produce the illumination gradient in azimuth in a second illumination configuration, said sensing apparatus being operable to capture a separate image of the surface of the object under the first and second illumination configurations, said first illumination configuration producing the image data to determine the surface gradients of the object and the second illumination configuration producing the image data to determine the orientation of the surface gradients of the object.

21. The optical inspection system of claim 20, wherein the second illumination configuration comprises at least two different azimuthal illumination configurations, said sensing apparatus being operable to capture a separate image of the surface of the object under the first illumination configuration and the two different azimuthal illumination configurations, said first illumination configuration producing the image data to determine the surface gradients of the object and the two different azimuthal illumination configurations collectively producing the image data to determine the orientation of the surface gradients of the object.

22. The optical inspection system of claim 15, wherein the at least one illumination parameter comprises illumination intensity.

23. The optical inspection system of claim 22, wherein the at least one illumination parameter comprises at least one spectral characteristic of the illumination.

24. A method for inspecting an object using an optical inspection system, comprising:
receiving illumination reflected from the surface of an object;
producing image data representing the intensity of the reflected illumination from spatial locations on the surface of the object; and
in response to said image data, discerning between illumination intensities of an illumination gradient associated with the reflected illumination to determine surface gradients at the spatial locations on the surface of the object.
